(19) United States
(12) Patent Application Publication
(10) Pub. No.: US 2022/0007650 A1
(43) Pub. Date: Jan. 13, 2022

(54) METHOD FOR ENCOURAGING BUDDING FROM GROWING POINT OF PLANT, FOR INHIBITING APICAL BUD GROWTH, AND FOR INCREASING NUMBER OF LATERAL SHOOTS, AND SUBSTANCES MADE BY AND USED IN THE METHOD

(71) Applicants: Chung-Yi LO, Taipei (TW); Heng-Juei KAO, Taipei (TW)

(72) Inventors: Chung-Yi LO, Taipei (TW); Heng-Juei KAO, Taipei (TW)

(21) Appl. No.: 16/921,965

(22) Filed: Jul. 7, 2020

(51) Int. Cl. A01N 63/14; A01N 63/50; C05F 3/00; C05F 17/00

(52) U.S. Cl. CPC A01N 63/14; C05F 17/00; C05F 3/00; A01N 63/50

(57) ABSTRACT

A method for encouraging budding from a growing point of a plant, for inhibiting apical bud growth, and for increasing the number of lateral shoots is disclosed along with the substances made by and used in the method. The excrement produced by the larvae of rhinoceros beetles during growth is used to cause physiological phenomena of plants, such as encouraging a plant to bud (including laterally) or sucker, or inhibiting the growth of the apical bud of a woody plant. These special effects include those achievable by certain plant hormones.

### BACKGROUND OF THE INVENTION

### 1. Technical Field

The present invention relates to a method for growing a plant and to substances made by and used in the method. More particularly, the invention relates to a method in which the excrement of rhinoceros beetle larvae is used to encourage budding (including lateral budding) or suckering or ramets of a plant, or to inhibit apical bud growth while promoting the elongation or fasciculation of lateral stems so as to shape the plant in the desired manner. The invention also relates to the substances made by and used in the method.

### 2. Description of Related Art

N/A.

### BRIEF SUMMARY OF THE INVENTION

The present invention relates to a method for encouraging budding from a growing point of a plant, for inhibiting apical bud growth, and for increasing the number of lateral shoots, and to the substances made by and used in the method. More specifically, the excrement produced by the larvae of rhinoceros beetles during growth is used to cause at least one of the following physiological phenomena of plants: budding, budding laterally, suckering, ramets and inhibited growth of the apical bud of a woody plant. These special effects include those achievable by certain plant hormones. The method starts by raising rhinoceros beetles with wood particle-based humus soil. While the larvae of the rhinoceros beetles feed and grow, they produce excrement that includes digested special compounds, digested microbial products, digested enzymes, and so on. The excrement plus the wood particle-based humus soil adjacent to where the larvae are raised, or a solvent extract of the excrement, is then used to effect an intended change in a plant. That is to say, the method produces substances capable of encouraging a physiological change in a plant.

The wood particle-based humus soil used to raise the rhinoceros beetle larvae is a fermented material produced by pulverizing the leaves and branches of broad-leaved trees; adding nutrients such as vegetable, molasses, and wheat/rice bran into the resulting wood particles; and fermenting the mixture with fungi (e.g., yeast) and effective microorganisms (EM). The excrement of the rhinoceros beetles is defined as the feces produced by the rhinoceros beetle larvae after digesting commercially available rhinoceros beetle feeding soil or common humus soil and is a mixture of a digested portion and an undigested portion of the rhinoceros beetle feeding soil or common humus soil. The excrement produced by the rhinoceros beetle larvae while they feed and grow is used in a concentration of 0.5%-100% and can be applied either by directly spreading the excrement and the wood particle-based humus soil adjacent to where the larvae are raised over the soil in which a target plant is grown, or by first performing an extraction process on the excrement with water, alcohol, or an organic solvent such as oil, acetone, or n-hexane and then using the extract as needed.

### BRIEF DESCRIPTION OF THE SEVERAL VIEWS OF THE DRAWINGS

N/A.

### DETAILED DESCRIPTION OF THE INVENTION

The growth of plants is controlled by plant hormones. The major classes and functions of known plant hormones are tabulated as follows:

| Plant hormone | |
|---|---|
| class | Main functions |
| Auxins | To promote elongation of cells and formation |
| | of adventitious roots, delay plant organ |
| | shedding, and encourage parthenocarpy |
| Gibberellins | To promote elongation of cells and |
| | germination, and enhance apical dominance |
| Cytokinins | To promote cell division, branching, and |
| | formation of lateral buds |
| Brassinosteroids | To promote cell elongation in stems and |
| | other plant organs |
| Ethylene | To promote swelling of stems and roots, |
| | inhibit plant growth (as in plant dwarfing), |
| | and hasten fruit ripening |
| Abscisic acid | A stress hormone produced in large |
| | quantities when under stress, to encourage |
| | hibernation and inhibit growth of roots and |
| | stems |
| Jasmonates | Produced in large quantities when plant is |
| | damaged or disease-stricken |
| polyamine | To promote plant growth and increase |
| | resistance |

Different plant hormones cause different physiological reactions in plants. The present invention can produce the same effects as some plant hormones, e.g., can promote lateral budding as do cytokinins. Certain effects (e.g., stem elongation) of the invention, however, are only similar to those of plant hormones. The invention is different from plant hormones in that the plant physiology-related features of the invention act on the nodes or growing points of stems (e.g., to encourage budding, including lateral budding), and that while inhibiting apical dominance, the invention encourages an apical bud to develop into a large number of lateral shoots and can increase the lengths of stems and promote the formation of fascicled leaves.

Preparation Method of the Present Invention:

Fermentation of rhinoceros beetle feeding soil and raising of larvae: The rhinoceros beetle feeding soil is the material required for growing rhinoceros beetles from eggs to pupae. The ingredients of the rhinoceros beetle feeding soil include pulverized wood (wood particles) and pulverized leaves as the base; wheat meal or barn or other plant scraps as additional nutrients; and effective microorganisms (EM) and various kinds of yeast for fermentation. Depending on their species, rhinoceros beetles need to be raised in the rhinoceros beetle feeding soil for one to three years. During the process, the larvae of the rhinoceros beetles feed mainly on commercially available rhinoceros beetle feeding soil. The fecal pellets discharged from the rhinoceros beetles after digesting the rhinoceros beetle feeding soil are used in combination with the feeding soil adjacent to where the rhinoceros beetles are raised, as a source of nutrients for plant cultivation.

The rhinoceros beetles used in the present invention belong to the subfamily Dynastinae. One typical species of rhinoceros beetles in Taiwan is Trypoxylus dichotomus, which is known in Mainland China as Allomyrina dichotoma. The rhinoceros beetle excrement used in the invention is obtained from Allomyrina dichotoma, Dynastes hercules, Megasoma elephus, Megasoma mars, Chalcosoma atlas, Xylotrupes philippinensis peregrinus, Xylotrupes gideon sumatrensis, Megasoma pachecoi, Augosoma centaurus, Eupatorus gracilicornis, and Golofa porter. Application of the excrement can bring about at least one of the following physiological phenomena of plants: budding, lateral budding, suckering, ramets, and inhibited apical bud growth plus fasciculation of lateral shoots. Thus, the objective of producing new plants, new buds, or dwarfed plants can be achieved.

Dynastinae, or rhinoceros beetles, are a subfamily of the scarab beetle family in the order Coleoptera. Most of the adult males have a horn, be it large or small. Some notable examples of rhinoceros beetles are Dynastes hercules, which are the longest beetles known today; Megasoma, which are noted for their weight; Golofa, renowned for their antenna-like horns; Chalcosoma, the largest in Asia; and the famous Trypoxylus dichotomus. There are currently nine species of rhinoceros beetles in Taiwan, two better-known examples of which are Trypoxylus dichotomus (Allomyrina dichotoma) and Xylotrupes philippinensis peregrinus. The life cycle of a rhinoceros beetle includes four stages: egg, larva, pupa, and imago. The larva stage has three instars, of which the third is the longest. Take Trypoxylus dichotomus for example. One generation of this species lasts for one year, and the life span of an adult in the field is about one to three months.

The names of some common rhinoceros beetles are tabulated as follows:

| | | |
|---|---|---|
| Dynastina | Augosoma | Golofa porter |
| | centaurus | |
| Megasoma pachecoi | Megasoma elephus | Megasoma mars |
| Dynastes hercules | Xylotrupina | Trypoxylus dichotomus |
| Xylotrupes davidis | Allomyrina | Xylotrupes |
| | dichotoma | philippinensis |
| | | peregrinus |
| Xylotrupes gideon | Chalcosomina | Haploscapanes |
| sumatrensis | | barbarossa |
| Chalcosoma atlas | Beckius beccari | Eupatorus |
| | | gracilicornis |
| Pachyoryctes solidus | | |

Once the foregoing are obtained and prepared, the larvae of the rhinoceros beetles are raised with the fermented plant-based humus soil. The fermented plant-based humus soil is composed of high-quality broad-leaved/deciduous trees, oak chips, and naturally decayed leaves, and is formulated with EM, wheat meal, special yeast, and various plant-based nutrients. (The concept of EM was first proposed in 1982 by Japanese scientist Professor Teruo Higa, who combined approximately 80 species of microorganisms from ten genera (mainly Bacillus, Photobacterium, Lactobacillus, Saccharomyces, and Actinomyce) into a microbial solution. EM features compositional complexity, performance stability, and multiple functions and is therefore advantageous over common one-species biological products, showing a high level of technological development. EM is a composite biological product containing about 80 species of microorganisms from ten genera such as Photobacterium, Lactobacillus (which are anaerobic), Saccharomyces (which are facultatively anaerobic), and Bacillus.) The above ingredients become fecal pellets after being consumed, digested, and discharged by the rhinoceros beetle larvae. The fecal pellets can produce physiological reactions in plants that are different from those by known plant hormones (except for, for example, the lateral budding effect also achievable with cytokinins), thus providing sufficient functionality and specificity as far as crops are concerned, exhibiting industrial applicability, novelty, and inventiveness. The present invention can be applied to plants to boost budding (including lateral budding) or suckering or ramets from growing points, to inhibit the growth of apical growing points while encouraging these growing points to produce lateral buds, and to thereby contribute to plant shaping.

With regard to budding, an experiment was conducted on stem tubers of potato. It was found that after stimulation with a water extract of the fecal pellets of the rhinoceros beetles for one day, the potatoes produced a large number of buds after three days. The control group was treated with deionized water, whereas experimental group 1 was treated with the excrement of a single species of rhinoceros beetles in Taiwan, namely Trypoxylus dichotomus, and experimental group 2 with a mixture of excrement of multiple species of rhinoceros beetles from other regions. According to the experiment results, the excrement of both the rhinoceros beetles in Taiwan and those from other parts of the world caused the potatoes to bud rapidly.

With regard to lateral budding and suckering (ramets), an experiment was performed on strawberry. In the control group, where common soil was used, an average of only 0.8 lateral bud was produced. By contrast, an average of 6.5 lateral buds were produced within two months after the strawberry was grown in soil added with the rhinoceros beetle excrement. When applied during the flowering and fruiting season of the strawberry, the rhinoceros beetle excrement caused lateral budding while the strawberry bore fruit. The excrement of the rhinoceros beetles was also found capable of causing other plants such as date palm, tequila, and plants of the genus Tillandsia to produce a large number of lateral buds.

With regard to inhibiting the growth of apical buds and encouraging the formation of lateral shoots, the present invention can be used to inhibit the apical growing point of a woody plant on one hand and cause a large number of lateral shoots to grow in the vicinity of the apical growing point on the other hand, with leaves growing densely on such shoots, thus changing the original growing mode of the plant. The invention, therefore, can help adjust the shape of a plant by controlling the growing mode of the plant. An experiment was conducted on grapefruit trees. The grapefruit trees grown in common soil had branches growing alternately, with one or two leaves one each branch, showing the typical alternate arrangement. After application of the rhinoceros beetle excrement in large quantities, the grapefruit trees stopped growing upward in the alternate manner. Instead, about 35 or more shoots fanned out from the apical growing point of each tree, and the number of these radiating shoots is many times more than the number of apical shoots in the control group per tree. The number of leaves on each branch was also changed. Seven to eight leaves grew densely from each branch. In an experiment with Stevia rebaudiana (Bertoni), which is a herbaceous plant with alternate or fascicled leaves and a moderate number of branching points on each stalk, cultivation in rhinoceros beetle excrement caused elongation of stalks and fasciculation of shoots (with more than 30 shoots fanning out from the stalk, i.e., ten times as many shoots as those growing from the stalk of each plant in the control group).

Whether the rhinoceros beetle excrement was applied over or mixed into the soil or was used in the form of an extract (e.g., stirred in a blender and then subjected to ultrasonic alcohol extraction), the foregoing effects of encouraging the growing points of a plant to bud laterally, promoting suckering and/or ramets, and increasing the number of buds were achieved all the same.

| | | | Experimental |
|---|---|---|---|
| | | | group with |
| | | Experimental | larva excrement |
| | | group with | of Megasoma |
| | | larva excrement | elephus, |
| | | of Trypoxylus | Megasoma mars, |
| | Control | dichotomus in | and Chalcosoma |
| Potato | group | Taiwan | atlas |
| Number of buds, day | 0 | 0 | 0 |
| 0 | | | |
| Number of buds, day | 0 | 0 | 0 |
| 1 | | | |
| Number of buds, day | 0 | 8 | 2 |
| 2 | | | |
| Number of buds, day | 0 | 11 | 8 |
| 3 | | | |
| Number of buds, day | 1 | 13 | 9 |
| 4 | | | |
| Number of buds, day | 4 | 14 | 9 |
| 5 | | | |
| Number of buds, day | 4 | 14 | 11 |
| 6 | | | |
| Number of buds, day | 4 | 14 | 12 |
| 7 | | | |
| Number of buds, day | 4 | 14 | 12 |
| 8 | | | |

Notes:
1. All the potatoes were immersed in their respective test solutions for one day.
2. The extract caused the corresponding potatoes to grow rapidly.
3. The control group was treated with deionized water. Experimental group 1 was treated with the excrement of a single species of rhinoceros beetles in Taiwan, namely Trypoxylus dichotomus. Experimental group 2 was treated with a mixture of excrement of multiple species of rhinoceros beetles from other regions.

| | | | Experimental |
|---|---|---|---|
| | | | group with |
| | | Experimental | larva excrement |
| | | group with | of Megasoma |
| | | larva excrement | elephus, |
| | | of Trypoxylus | Megasoma mars, |
| | Control | dichotomus in | and Chalcosoma |
| Potato | group | Taiwan | atlas |
| Number of buds | 0 | 0 | 0 |
| longer than 1 cm, | | | |
| day 0 | | | |
| Number of buds | 0 | 0 | 0 |
| longer than 1 cm, | | | |
| day 1 | | | |
| Number of buds | 0 | 0 | 0 |
| longer than 1 cm, | | | |
| day 2 | | | |
| Number of buds | 0 | 0 | 0 |
| longer than 1 cm, | | | |
| day 3 | | | |
| Number of buds | 0 | 3 | 1 |
| longer than 1 cm, | | | |
| day 4 | | | |
| Number of buds | 0 | 9 | 3 |
| longer than 1 cm, | | | |
| day 5 | | | |
| Number of buds | 0 | 11 | 6 |
| longer than 1 cm, | | | |
| day 6 | | | |
| Number of buds | 0 | 12 | 7 |
| longer than 1 cm, | | | |
| day 7 | | | |
| Number of buds | 0 | 12 | 7 |
| longer than 1 cm, | | | |
| day 8 | | | |

Notes:
1. All the potatoes were immersed in their respective test solutions for one day.
2. The extract caused the corresponding potatoes to grow rapidly.
3. The control group was treated with deionized water. Experimental group 1 was treated with the excrement of a single species of rhinoceros beetles in Taiwan, namely Trypoxylus dichotomus. Experimental group 2 was treated with a mixture of excrement of multiple species of rhinoceros beetles from other regions.

Differences in Stevia rebaudiana (Bertoni) Between the Experimental Groups and the Control Group

| | | | Experimental |
|---|---|---|---|
| | | | group with |
| | | Experimental | larva excrement |
| | | group with | of Megasoma |
| | | larva excrement | elephus, |
| | | of Trypoxylus | Megasoma mars, |
| Stevia rebaudiana | Control | dichotomus in | and Chalcosoma |
| (Bertoni) | group | Taiwan | atlas |
| Plant height | 39 cm | 67 cm | 71 cm |
| (measured from the | | | |
| base of stalk) | | | |
| Number of lateral | 26 | 55 | 61 |
| stems longer than | | | |
| 5 cm | | | |
| Number of lateral | 6 | 50 | 57 |
| stems longer than | | | |
| 20 cm | | | |
| Average distance | 2.8 cm | 11.3 cm | 13.8 cm |
| from the base of | | | |
| the lowest leaf | | | |
| on a lateral stem | | | |
| to the base of the | | | |
| lateral stem | | | |
| Leaf distribution | Evenly | Distributed | Distributed |
| | distributed | only along the | only along the |
| | along the | middle and | middle and |
| | entire | upper sections | upper sections |
| | plant | of the stalk | of the stalk |

Note:
Observation was made after seedlings were cultivated for four months.

Differences in Grapefruit Between the Experimental Group and the Control Group

| | | Experimental group |
|---|---|---|
| | | with larva |
| | | excrement of |
| | | Trypoxylus |
| | | dichotomus in |
| Grapefruit | Control group | Taiwan |
| Number of branches | 8 | 67 |
| within a 50 cm range | | |
| extending downward | | |
| from the tip of the | | |
| plant | | |
| Average number of | 2.9 | 9.4 |
| leaves on each | | |
| branch within a 70 | | |
| cm range extending | | |
| downward from the | | |
| tip of the plant | | |
| (counting only | | |
| leaves on branches | | |
| less than 15 cm | | |
| long) | | |
| Leaf distribution | Leaves grew | Leaves grew |
| | alternately on the | sparingly on the |
| | trunk, with 2~4 | trunk. Most of the |
| | leaves at the tip of | leaves grew at |
| | each branch. | branch tips, with |
| | | up to 8~13 leaves at |
| | | each tip. |

The foregoing experiments have fully demonstrated the effects of the present invention and the huge differences between the invention and the prior art, and while the invention has been disclosed through the preferred embodiments described above, those embodiments are not intended to be restrictive of the scope of the invention. All equivalent changes and modifications that are based on the technical features and spirit of the appended claims shall fall within the scope of the invention.

What is claimed is:

1. A method for encouraging budding from a growing point of a plant, for inhibiting apical bud growth, and for increasing the number of lateral shoots, comprising the steps of:
raising larvae of rhinoceros beetles with wood particle-based humus soil in order to obtain excrement produced by the larvae of the rhinoceros beetles after feeding during growth, and thereby obtain substances capable of promoting a physiological change in the plant, wherein the excrement comprises digested special compounds, digested microbial products, and digested enzymes; and
causing a physiological phenomenon of the plant with the excrement and the wood particle-based humus soil adjacent to where the larvae are raised, or with a solvent extract of the excrement, in order to effect a desired change in the plant, wherein the physiological phenomenon is budding, budding laterally, suckering, ramets, inhibited apical dominance accompanied by fasciculation, or a physiological phenomenon causable by a plant hormone.

2. The method of claim 1, wherein the rhinoceros beetles are selected from the group consisting of Augosoma centaurus, Golofa porter, Megasoma pachecoi, Megasoma elephus, Megasoma mars, Dynastes hercules, Trypoxylus dichotomus, Xylotrupes davidis, Allomyrina dichotoma, Xylotrupes philippinensis peregrinus, Xylotrupes gideon sumatrensis, Haploscapanes barbarossa, Chalcosoma atlas, Beckius beccari, Eupatorus gracilicornis, and Pachyoryctes solidus.

3. The method of claim 1, wherein the wood particle-based humus soil with which the larvae of the rhinoceros beetles are raised is a fermented material produced by pulverizing leaves and branches of broad-leaved trees to produce wood particles, adding nutrients into the wood particles to produce a mixture, and fermenting the mixture with a fungus and effective microorganisms (EM); the nutrients comprise vegetable, molasses, and wheat bran or rice bran; the fungus comprises yeast; and the excrement of the larvae of the rhinoceros beetles is defined as feces produced by the larvae of the rhinoceros beetles after digesting commercially available rhinoceros beetle feeding soil or common humus soil and is a mixture of a digested portion and an undigested portion of the commercially available rhinoceros beetle feeding soil or of the common humus soil.

4. The method of claim 1, wherein the budding is budding from a growing point of a stem, and the stem is a stem tuber of a plant.

5. The method of claim 1, wherein the suckering or the budding laterally is producing suckers or lateral buds outward from a center defined by a growing point of the plant such that the plant features a notable increase in suckers or lateral buds, and the plant is strawberry, a plant of the genus Tillandsia, tequila, or date palm.

6. The method of claim 1, wherein the inhibited apical dominance accompanied by the fasciculation is inhibited growth of an apical growing point of a stem of the plant plus producing a large number of outwardly extending shoots, dense fascicled leaves, or elongated stems and is useful in horticultural management and plant shaping, and the plant is grapefruit, which shows inhibited growth of an apical growing point and a significant increase in lateral branches and fascicled leaves when the method is applied, or Stevia rebaudiana (Bertoni), which produces a large number of elongated stems and lateral shoots when the method is applied.

7. The method of claim 1, wherein the excrement produced by the larvae of the rhinoceros beetles after feeding during growth is used in a concentration of 0.5%˜100% either by directly applying the excrement and the wood particle-based humus soil adjacent to where the larvae are raised over soil in which the plant is grown, or by first performing a water-based, alcohol-based, or organic solvent-based extraction process on the excrement to produce an extract and then applying the extract, wherein the organic solvent is oil, acetone, or n-hexane.

8. Substances made by and used in the method of claim 1.
